(19) United States
(12) Patent Application Publication
(10) Pub. No.: US 2016/0179494 A1
(43) Pub. Date: Jun. 23, 2016

(54) INTEGRATION OF AN ARBITRARY SERVER INSTALLED AS AN EXTENSION OF A COMPUTING PLATFORM

(71) Applicants: Vladimir Pavlov, Veliko Tarnovo (BG); Radoslav Ivanov, Sofia (BG); Peter Matov, Sofia (GB); Iliyan Nenov, Sofia (BG); Petio Petev, Sofia (BG); Dimitar Mihaylov, Gabrovo (BG)

(72) Inventors: Vladimir Pavlov, Veliko Tarnovo (BG); Radoslav Ivanov, Sofia (BG); Peter Matov, Sofia (GB); Iliyan Nenov, Sofia (BG); Petio Petev, Sofia (BG); Dimitar Mihaylov, Gabrovo (BG)

(21) Appl. No.: 14/574,423

(22) Filed: Dec. 18, 2014

(51) Int. Cl. G06F 9/445; H04L 29/08

(52) U.S. Cl. CPC G06F 8/61; H04L 67/2804; H04L 67/1097

(57) ABSTRACT

A package including a native monitoring library and a shared memory API interface to the native monitoring library is integrated into an arbitrary server to reuse monitoring performed by a server instance of a cluster of server instances. The one or more extension server nodes are installed on a server instance from the cluster of server instances based the arbitrary server. Status information is reported to the shared memory via the shared memory API by the installed extension server nodes. Logging format native to the arbitrary server is reconfigured according to input values of configuration parameters that specify logging format native to server nodes running on the server instance. An application is deployed on each of one or more extension server nodes. The deployment operation of the application is transactional. Security control for the deployed application is delegated to the cluster of server instances.

### BACKGROUND

Existing computing platforms are based on technologies that may rapidly become obsolete. There is demand for constant update to latest available technologies, so that new functionality and features can be utilized. However, updating an entire computing platform providing application integration, development and runtime environments to latest technology specifications may be tedious and costly. At the same time, new systems providing such application development and runtime environments that, from the outset, are designed based on latest technologies could be offered by various vendors. However, those systems may lack functionality enjoyed by customers of the existing computing platforms.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1A illustrates a high level architecture of a cluster of server instances of a computing platform.

FIG. 1B illustrates exemplary system architecture where one or more extension server nodes are installed within one or more server instances of a cluster of server instances.

FIG. 2 illustrates a process to deploy an application on one or more extension server nodes of a server instance of a cloud computing platform, according to one embodiment.

FIG. 3 illustrates exemplary system architecture 300 to deploy an application on one or more extension server nodes of a server instance of a cloud computing platform, according to one embodiment.

FIG. 4 illustrates a process for secure communication from a client system to an application deployed on an extension server node, according to one embodiment.

FIG. 5 illustrates a process to delegate security control for an application running on an extension server node to a cluster of server instances, according to one embodiment.

FIG. 6 illustrates a system to delegate security control for an application running on an extension server node to a cluster of server instances, according to one embodiment.

FIG. 7 illustrates a process to integrate monitoring and logging performed by a server instance of a cluster of server instances to an arbitrary server that is into be installed as an extension server node on the server instance, according to one embodiment.

FIG. 8 illustrates an exemplary computer system, according to one embodiment.

### DETAILED DESCRIPTION

Embodiments of techniques smart retail space are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

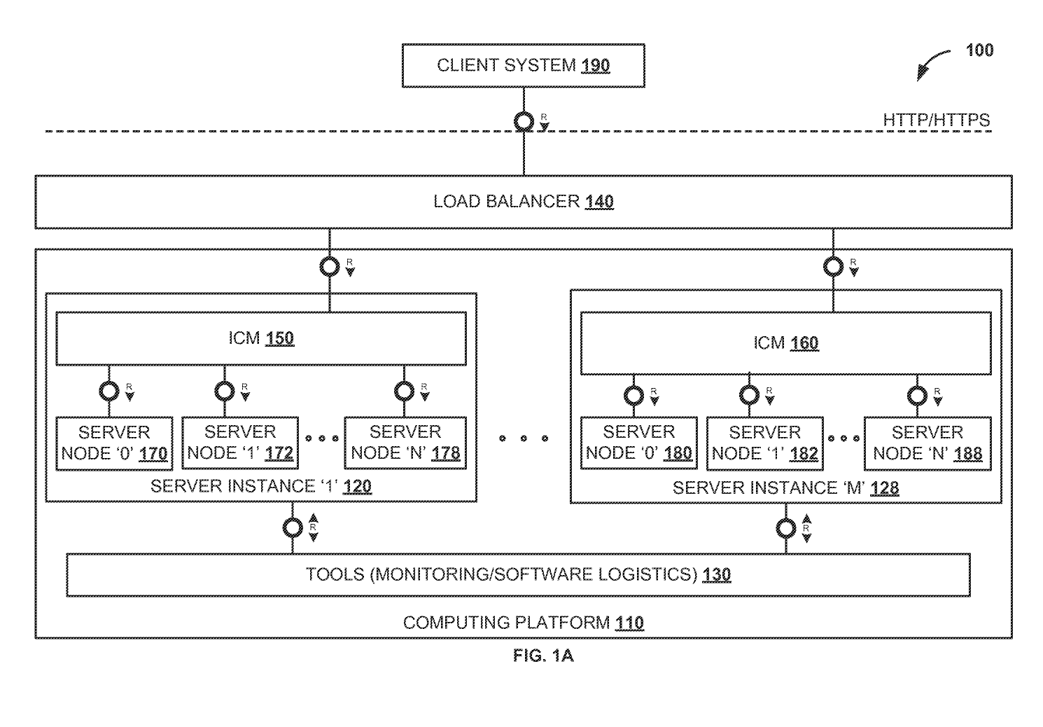

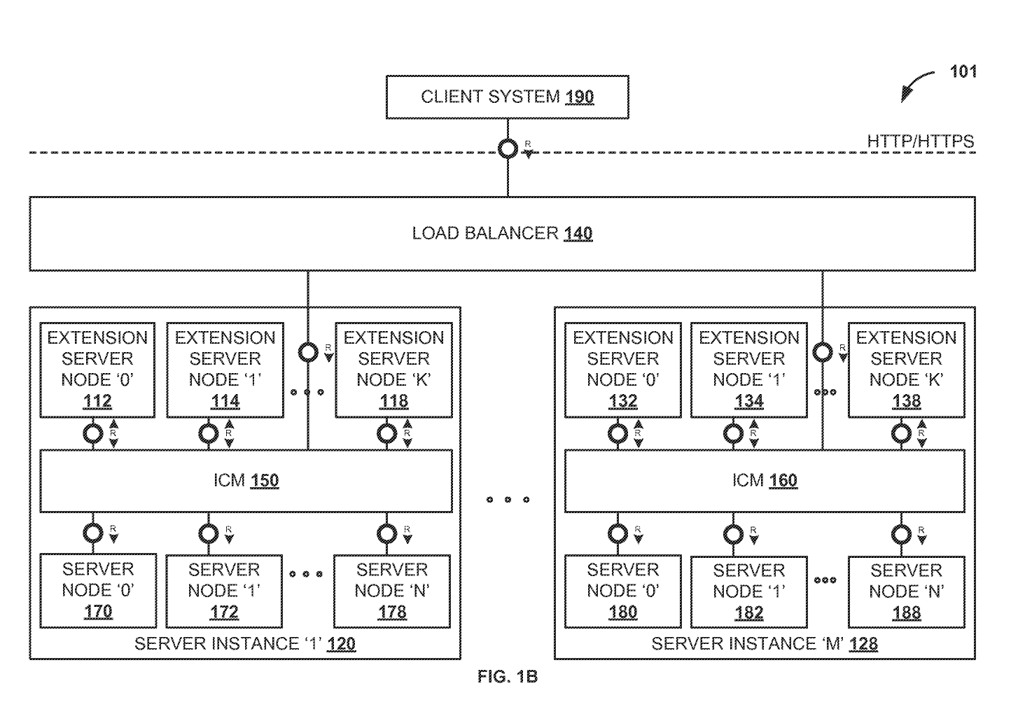

FIG. 1A illustrates a high level architecture 100 of a cluster of server instances of a computing platform 110. Computing platform 110 is an application and integration technology platform. Computing platform 110 may provide development and runtime environment for applications. In one embodiment, computing platform 110 may include one or more products of SAP® NetWeaver® provided by SAP SE. In another embodiment, cloud computing platform 110 may be Oracle® Fusion or other similar technology platforms provided by other vendors.

Computing platform 110 may include one or more server stances such as server instance ‘1’ 120 to server instance ‘M’ 128. A server instance defines a group of resources such as memory, work processes, etc., usually in support of one or more application server nodes or database server nodes within a client-server environment. For example, server node ‘0’ 170, server node ‘1’ 172, and server node ‘N’ 178 may share the same memory areas (e.g., shared file system) at server instance ‘1’ 120 and may be controlled by the same dispatcher process, e.g., Internet Communication Manager (ICM) 150. Similarly, node server ‘0’ 180, server node ‘1’ 182, and server node ‘N’ 188 may share the same memory areas at server instance ‘M’ 128 and may be controlled by the same dispatcher process, e.g., ICM 160. For the different server instances 120-128, separate directories may be defined on the operating system on which the server instance is to run; entries are created in the operating system configuration files for the server instance; communication entries may be created in the host where the server instance is to run, instance profiles for the instance may be created, etc. Instance profiles are operating system files that contain instance configuration information. Individual configuration parameters may be customized to the requirements of individual instances 120-128. In the instance profile, parameters that may be configured include, but are not limited to, runtime environment of the server instance (e.g., resources such as main memory size, shared memory, roll size); which services the instance itself provides (e.g., work processes, Java processes or server nodes); location of other services that can be used (e.g., a database host); etc.

In one embodiment, server instances 120-128 may be instances of SAP® NetWeaver Application Server. In one embodiment, server instances 120-128 may be clustered to increase capacity, scalability and reliability of computing platform 110. Server instances 120-128 may share a common configuration and load may be distributed evenly across server instances 120-128 in the cluster. A server instance from server instances 120-128 may include one or more server nodes that may also be clustered. For example, server instance ‘1’ 120 includes server node ‘0’ 170, server node ‘1’ 172, server node ‘N’ 178. Similarly, server instance ‘M’ 128 includes server node ‘0’ 180, server node ‘1’ 182, and server node ‘N’ 188. In one aspect, server nodes installed and running within instances may be Java processes. Tools 130 may be software for handling monitoring, logging or software logistics of instances 120-128. For example, instances 120-128 may be started, stopped, updated, upgraded, etc., by a tool from tools 130. In one embodiment, tools 130 may include a startup framework that starts, stops, and monitors the cluster of instances 120-128.

Load balancer 140 balances the load to ensure an even distribution across instances 120-128. In one embodiment, load balancer 140 may permit communication between instances 120-128 and the Internet. Load balancer 140 may be the entry point for Hypertext Transfer Protocol (HTTP) requests to instances 120-128. Load balancer 140 can reject or accept connections. When it accepts a connection, load balancer 140 distributes the request among instances 120-128 to balance respective workload. Load balancer 140 can reject requests based on Uniform Resource Locators (URLs) that are defined to be filtered. Load balancer 140, therefore, can restrict access to computing platform 110. Thus, load balancer 140 adds an additional security check and also balances load in cloud computing platform 110. In one embodiment, load balancer 140 may be SAP® Web Dispatcher.

In one embodiment, Internet communication managers (ICMs) 150-160 permit communication between servers within instance ‘1’ 120 and instance ‘M’ 128, respectively, and other external systems such as client system 190 via the protocol HTTP, Hypertext Transfer Protocol Secure (HTTPS) and Simple Mail Transfer Protocol (SMTP). For example, ICM 150 permits communication between server node ‘0’ 170, server node ‘1’ 172, and server node ‘N’ 178 and the Internet. Similarly, ICM 160 permits communication between server node ‘0’ 180, server node ‘1’ 182, and server node ‘N’ 188 and the Internet. ICM 150 and ICM 160 are separate processes monitored by load balancer 140. In one embodiment, ICM 150 distributes incoming requests directly to one of servers 170-178. Similarly ICM 160 distributes incoming requests directly to one of servers 180-188. ICM 150-160 act as load balancers of incoming requests in addition to being communication managers.

Various vendors may provide different application development and runtime environments. For example, various Java Platform Enterprise Edition (EE) compliant servers may be offered by different providers that may be designed based on different, for example, more current technologies. Also, new versions of the application development and runtime environments of current computing platform may be developed and provided. However, those application development and runtime environments may lack the functionality of computing platforms already existing such as computing platform 110. In one embodiment, one or more arbitrary servers are installed as one or more extensions of instances 120-128 of computing platform 110. The arbitrary servers may be application servers. In one embodiment, the arbitrary servers may be based on Java EE such as a Java EE Web-profile server.

FIG. 1B illustrates exemplary system architecture 101 where one or more extension server nodes are installed within one or more server instances of a cluster of server instances, according to one embodiment. In FIG. 1A, an exemplary cluster of server instances is illustrated such as cluster of server instances 120-128 with installed server nodes 170-178 and server nodes 180-188, respectively. An arbitrary server may be installed a number of times as extension server nodes in the different server instances 120-128. For example, extension server node ‘0’ 112, extension server node ‘1’ 114, and extension server node ‘K’ 118 represent an arbitrary server installed ‘k’ number of times in server instance ‘1’ 120. Also, extension server node ‘0’ 132, extension server node ‘ ’ 134, and extension server node ‘K’ 138 represent the arbitrary server installed ‘k’ number of times in server instance ‘M’ 128. The arbitrary server may be a server of type different from the type of server nodes 170-178 or 180-188 existing prior installation of the arbitrary server. Alternatively, the arbitrary server may be of the same type server nodes 170-178 and 180-188, but a different version, for example, later version.

Extension server nodes 112-118 are provisioned in the file system of server instance ‘1’ 120. In one embodiment, when started, extension server nodes 112-118 may be running as individual processes within server instance ‘1’ 120. Similarly, extension server nodes 132-138 are provisioned in the file system of server instance ‘M’ 128. In one embodiment, when started, extension server nodes 132-138 may be running as individual processes within server instance ‘M’ 128. In one embodiment, by installing one or more Java EE extension server nodes in one or more application server Java instances, one or more Java EE 6 Web-Profile processes may be provisioned and configured in the one or more application server Java instances.

Customers of computing platform 110 may have expectations for the user experience and functionality provided by computing platform 110. In one embodiment, installation of extension server nodes 112-118 and 132-138 within one or more server instances 120-128, respectively, of a cluster of server instances, may provide a level of user experience with computing platform 110, the same or similar to the user experience prior installation of the extension server nodes 112-118 and 132-138. For example, deployment of applications on the extension server nodes may be performed in similar manner, from the perspective of the customers, as when deployment of applications is performed on the one or more server nodes. Similarly, monitoring, security, logging, communication, lifecycle management of applications deployed on the extension server nodes may be performed in similar manner, as perceived by the customers, as if those functionalities are performed on the one or more server nodes. Further, functionality provided by computing platform 110 prior installing extension server nodes 112-118 and 132-138 is also available in addition and in parallel to the functionality provided by the installed extension server nodes 112-118 and 132-138. Thus, extension server nodes 112-118 and 132-138 are integrated and running in parallel to server nodes 170-178 and 180-188, where extension server nodes 112-118 and 132-138 may be based on a technology different from the technology on which server nodes 170-178 and 180-188 are based. Extension server nodes 170-178 and 180-188 are arbitrary servers that may be plugged into a server instance from server instances 120-128 and that may run in parallel with pre-existing server nodes 170-178 and 180-188 of the server instances 120-128, respectively.

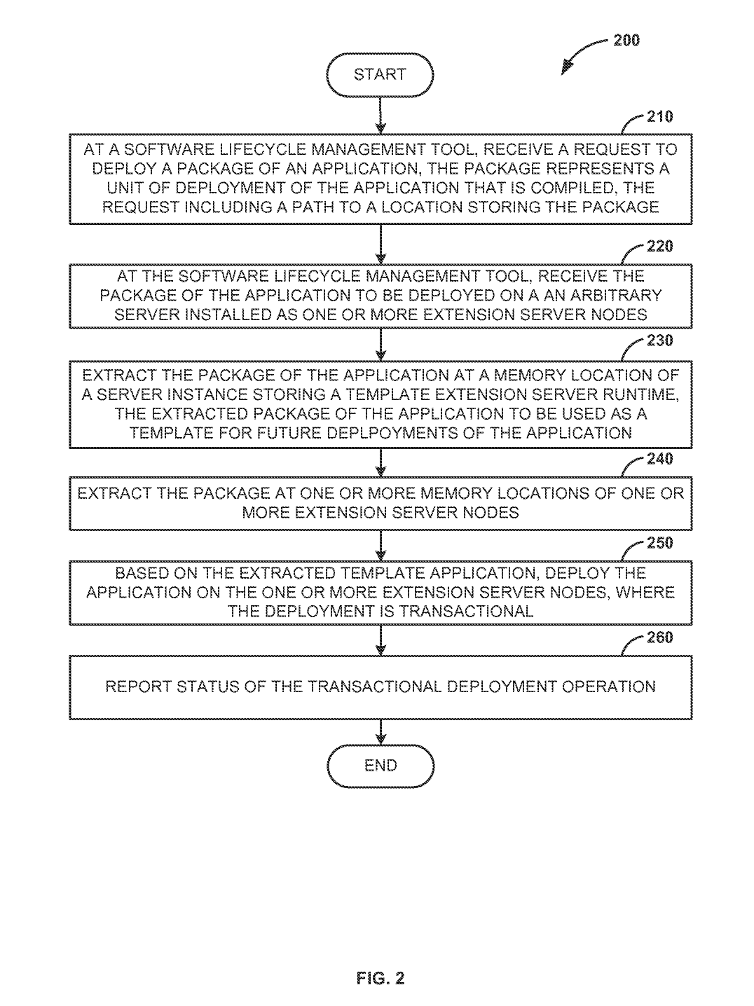

FIG. 2 illustrates process 200 to deploy an application on one or more extension server nodes of a server instance of a cloud computing platform, according to one embodiment. At 210, a request to deploy a package of an application is received at a software lifecycle management tool. The package represents a unit of deployment of the application that is compiled and packaged. The application may be based on technology supported by the one or more extension server nodes. In one aspect, the application may be designated to be deployed on a type of server as the one or more extension server nodes. The request may include a path to a memory location storing the package to be deployed. The application is to be deployed and thus installed on one or more extension server nodes (e.g., extension server nodes 112-118 and 132-138 in FIG. 1B) on a server instance of a cloud computing platform (e.g., cloud computing platform 110 in FIG. 1A). The package may be of various formats including, but not limited to, ZIP, RAR, Web application Archive (WAR), Java Archive (JAR), SAP® Archive (SAR), Software Deployment Archives (SDA) and other proprietary or non-proprietary archive files. The package may include executable and other files related to the application. In one embodiment, the software lifecycle management tool may be SAP® Software Update Manager. In various embodiments, various software lifecycle management tools may be used provided by same or different providers. In other embodiments, deployment may be performed by a batch file or other script file instead of a software lifecycle management tool.

At 220, the package of the application to be deployed is received or accessible at the software lifecycle management tool, according to one embodiment. The application to be deployed on an arbitrary server installed as the one or more extension server nodes of the server instance. At 230, the package of the application is extracted at a memory location of the server instance. The memory location of the server instance may store a template extension server runtime. The template extension server runtime represents the raw runtime based on which one or more extension server nodes are installed in the server. The template extension server runtime is used as foundation or template for subsequent, future installations of extension server nodes onto server instances of the computing platform. The package may be extracted in a sub directory of a directory where the template extension server runtime is stored. The extracted package of the application to be used as template for future deployments of the application. The package is extracted at the memory location of the server instance storing the template extension server runtime so that when a new extension server node is installed the application will be installed together with the new extension server node.

In one embodiment, at 240, in addition, the package may be extracted at one or more memory locations of the one or more extension server nodes.

At 250, the application is deployed on the one or more extension server nodes based on the extracted template application. The deployment operation is transactional, where the deployment is completed if it is successfully completed on each extension server node from the one or more extension server nodes. Old server nodes running in the server instance remain unaffected by the deployment of the application. At 260, status of the transactional deployment operation is reported. In one embodiment, deployment results may be retrieved from all extension server nodes. The deployment results may be aggregated for the purposes of determining the status of the deployment operation. In one embodiment, deployment results may be obtained from file systems of the extension server nodes.

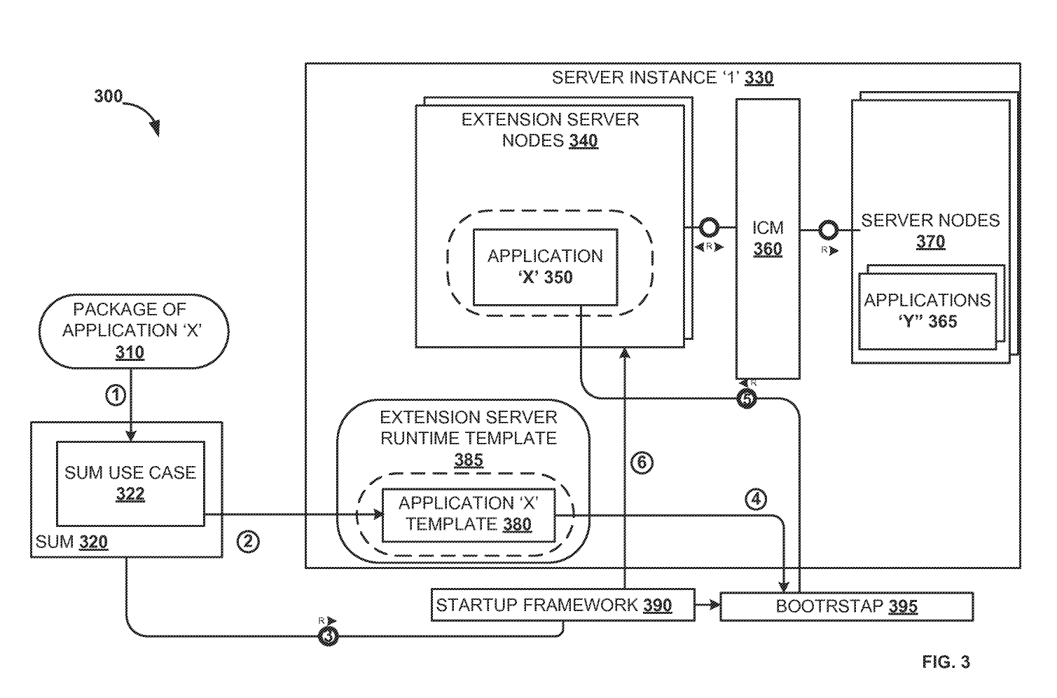

FIG. 3 illustrates exemplary system architecture 300 to deploy application ‘X’ on one or more extension server nodes 340 of server instance ‘1’ 330 of a cloud computing platform, according to one embodiment. Software update manager (SUM) 320 may include use cases for deployment of various types of artifacts. In one embodiment, SUM use case 322 is implemented to deploy the application onto the one or more extension server nodes 340. SUM use case 322 may receive as input configuration parameters a location from where to read package of application ‘X’ 310 and other configuration parameters. Package of application ‘X’ 310 may be an archive file that includes executable files of the application to be deployed. Based on the technology application ‘X’ 310 is based on, SUM use case 322 determines that package of application ‘X’ 310 may be designated to be deployed on the one or more extension server nodes 340.

SUM use case 322 reads package of application ‘X’ 310 from the location specified by the input parameters (e.g., step 1). Upon reading package of application ‘X’ 310, package of application ‘X’ 310 extracts package of application ‘X’ 310 to a memory location at the file system of server instance ‘1’ 330, where extension server runtime template is stored (e.g., step 2). For example, application ‘X’ template 380 represents extracted application ‘X’ from package of application ‘X’ 310 at extension server runtime template 385. Application ‘X’ template 380 to be used as base or template for deployment of application ‘X’ to extension server nodes 340.

Server instances (e.g., server instances ‘1’ 120 and ‘M’ 128 in FIG. 1A and FIG. 1B) in a cluster of server instances may be started, stopped, and monitored using a startup framework such as startup framework 390. Startup framework 390 for a server instance may provide centralized management of server nodes in the server instance such as server nodes 170-178 and servers nodes 180-188 (in FIG. 1A and FIG. 1B). Startup framework 390 may monitor life cycle of the server nodes within the server instance. Further, startup framework 390 may manage and monitor ICM processes within the server instance. In case of cluster server node failure, the framework automatically restarts the corresponding server node. The startup framework may serve as a single point of administration for starting, restarting, stopping, and monitoring of the server nodes. Startup framework 390 may display trace files, system environment of each instance, and system environment of the computing platform.

Once application ‘X’ template 380 is generated by extracting package of application ‘X’ 310 to extension server runtime template 385, SUM 320 starts startup framework 390 (e.g., step 3). In turn, startup framework 390 starts bootstrap 395. Bootstrap 395 reads application ‘X’ template 380 (e.g., step 4). Upon reading application ‘X’ template 380, bootstrap 395 deploys application ‘X’ by multiplying application ‘X’ template 380 on the extension server nodes 340 (e.g., step 5). An application ‘X’ 350 is deployed on each extension server node from extension server nodes 340. Once, extension server bootstrap 395 successfully finishes with installation of application ‘X’ 350 on extension server nodes 340, startup framework 390 starts the deployed application ‘X’ 350 (e.g., step 6). In one embodiment, steps 1 to 6 may repeat for other serve instance such server instances 120-128 in FIG. 1A and FIG. 1B.

In one embodiment, application ‘X’ 350 may provide functionality that is coupled to functionality provided by server nodes 370. In such case, requests from application ‘X’ 350 to applications ‘Y’ 365, for example, may be forwarded via Internet Communication Manager 360. Thus, both application ‘X’ 350 and applications ‘Y’ 365 that may be based on different technology may run in parallel.

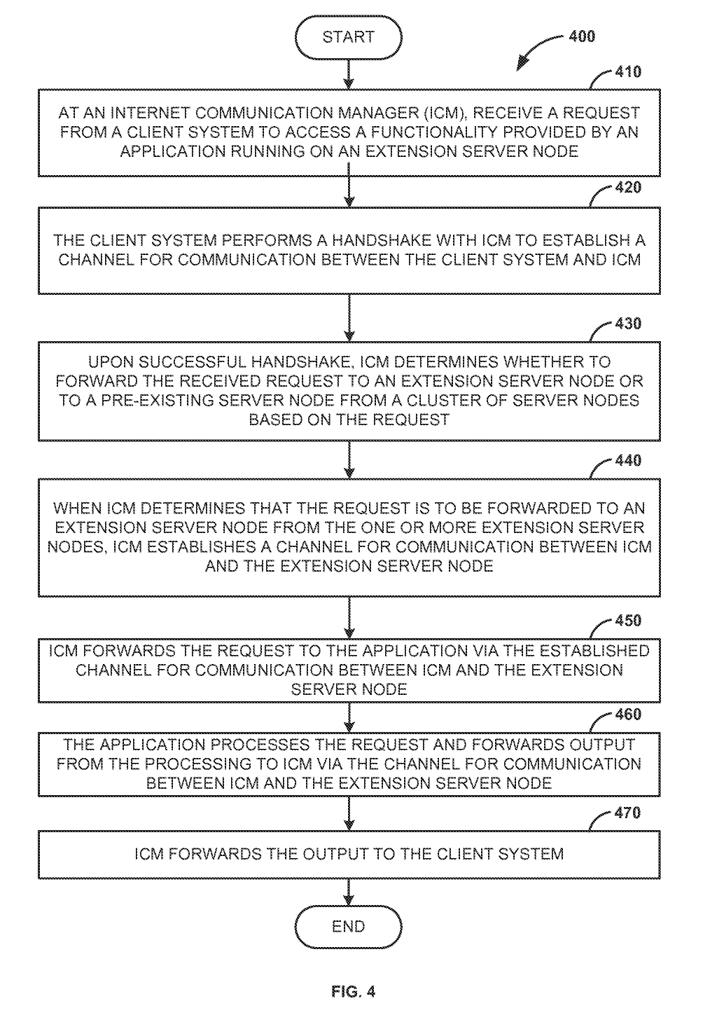

Once, application ‘X’ 350 is successfully deployed, secure communication to application ‘X’ 350 may be necessary. FIG. 4 illustrates process 400 for secure communication from a client system to an application deployed on an extension server node, according to one embodiment. At 410, a request from a client system is received at an internet communication manager such as ICM 150 and ICM 160 in FIG. 1A and FIG. 1B. The request is for accessing functionality provided by an application running on an extension server node from one or more extension server nodes. For example, a client system may request to access functionality provided by application ‘X’ 350 deployed and running on an extension server node from extension server nodes 340 (FIG. 3). At 420, the client system performs a handshake with ICM to establish a channel for communication between the client system and ICM. Upon successful handshake, at 430, ICM determines, based on the request, whether to forward the received request to an extension server node or to a pre-existing server node from a cluster of server nodes. When ICM determines that the request is to be forwarded to an extension server node from the one or more extension server nodes, ICM established a channel for communication between ICM and the extension server node. At 450, ICM forwards the request to the application via the established channel for communication between ICM and the extension server node. At 460, the application processes the requests and forwards output from the processing to ICM via the channel for communication between ICM and the extension server node. At 470, ICM forwards the output to the client system, directly or indirectly via a load balancer such as load balancer 140 in FIGS. 1A-1B.

Once, application ‘X’ 350 is successfully deployed, security and access control to application ‘X’ 350 may be necessary. Typically, when a user or a client system requests access to application ‘X’ 350, authentication may be performed within respective extension server node of extension server nodes 340. For example, by searching within local data stores available to the extension server node. However, such approach requires development and generation of user management data such as users, user roles, and access rights associated with the user roles, etc. This approach may be tedious and ineffective. In one embodiment, instead of performing authentication and authorization locally to extension server nodes 340, security control may be delegated to a server instance from the cluster of server instances.

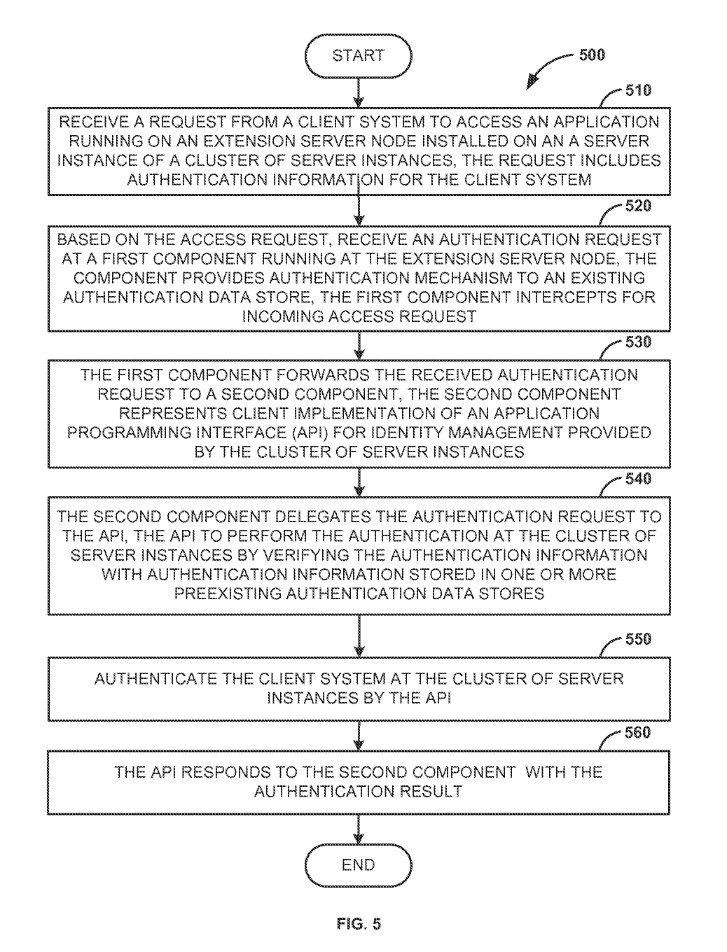

FIG. 5 illustrates process 500 to delegate security control for an application running on an extension server node to a server instance of a cluster of server instances, according to one embodiment. At 510, a request from a client system to access an application running on an extension server node is received. The extension server node is installed on a server instance of a cluster of server instances. The request may include authentication information for the client system such as a user name and a password of a user of the client system requesting access to the application from the client system. Based on the access request, at 520, an authentication request is received at a first component running at the extension server node. The first component provides authentication mechanism to an existing data source. The component intercepts for incoming access requests.

At 530, the first component forwards the received authentication request o a second component. The second component represents a client implementation of an application programming interface (API) for identity management. The second component running at the extension server node. The API for identity management provided by the cluster of server instances. At 440, the second component delegates the authentication request to the API. In particular, the request is delegated to a server side implementation of the API to perform the authentication. The authentication to be performed by verifying the authentication information received with the authentication request by comparing to authentication information stored in one or more pre-existing authentication data stores. At 550, the client system is authenticated at the cluster of server instances by the API. In one embodiment, in response to the authentication request, authentication and authorization may be performed by the API. At 560, the API responds to the second component with the authentication result. In one embodiment, by delegating access and security control to a server instance from the cluster of server instances, user management data or authentication and authorization for the server instance that is developed over time may be reused for newly deployed applications running one or more extension server nodes. Thus, the one or more extension server nodes are integrated into the server instance by reusing access and security control performed by the server instance.

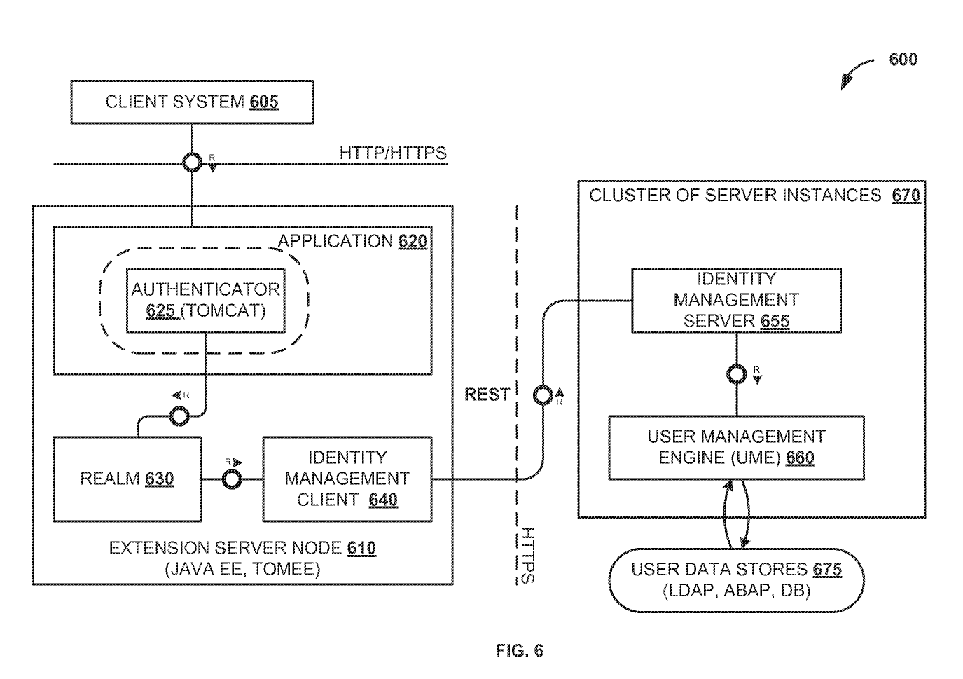

FIG. 6 illustrates system 600 to delegate security control for application 620 running on an extension server node 610 to a cluster of server instances 670, according to one embodiment. In one embodiment, authenticator 625 enforces security constraints for application 620. When processing access requests from client system 605 to application 620, authenticator 625 may forward the access requests to realm 630 for authentication. Realm 630 may be configured as the source of users and roles corresponding to the users. For example, realm 630 could be an Apache Tomcat® based component that performs authentication and authorization. In one embodiment, other components may be used based on different technology. Typically, realm 630 may perform authentication and authorization by searching within local data stores available to the server, where realm 630 resides, e.g., extension server node 610. However, authenticator 625 allows for the specification of various methods for authentication. In one embodiment, different mechanisms for authentication may be specified in a security properties file associated with authenticator 625. For example, in the security properties file, it may be specified that authentication requests be forwarded from realm 630 to identity management client 645. Thus, based on the access request received at authenticator 625, an authentication request is received at realm 630, which runs at extension server node 610.

Identity management client 610 may be client-side implementation of API for identity management, according one embodiment. Server side of the API for identity management may be identity management server 655. Identity management server 655 may perform security control such as management of users, roles and respective authentications and authorizations. Identity management server 655 may perform authentication and authorization for applications running on server nodes at server instances of the cluster of server instances 670. In one embodiment, identity management server 655 may retrieve user data from user data stores 675 via user management engine (UME) 660. UME 660 is a user management component that may perform user management, single-sign-on, secure access to distributed applications, etc. Examples of user data stores 675 may include, but are not limited to, databases, Lightweight Directory Access Protocol (LDAP), proprietary ABAP system such as SAP® R/3 system, etc. In one embodiment, client identity management 610 and identity management server 655 may be implementations based on Simple Cloud Identity Management (SCIM) specification. In one embodiment, upon installing an arbitrary extension server node such as extension server node 610, a memory location may be specified where executables file of identity management client 610 are stored, so that upon start of extension server node 610, identity management client 610 may be loaded, for example, into a Java virtual machine on which extension server node 610 runs.

Upon receiving an authentication request at realm 630, realm 630 forwards the received authentication request to identity management client 610, as specified in the security properties file. In turn, identity management client 640, delegates the authentication request to identity management server 655. Identity management server 655 performs the authentication at the cluster of server instances 670 by verifying authentication information received included in the authentication request with authentication information stored in data stores 675. Upon successful verification, client system 605 is authenticated at cluster of server instances 670 by identity management server 655. Authentication and authorization is delegated from extension server node 610 to cluster of server instance 670. By delegating security control including authentication and authorization to cluster of server instances 670, security control provided by cluster of server instances 670 is reused for applications running on one or more extension server nodes such extension server node 620. Upon authentication of client system 605, identity management server 655 responds to identity management client 640 with the authentication result.

Once arbitrary servers are installed as extensions, for example, extension server nodes 112-118 and 132-138, in a server instance from a cluster of server instances, status of the extension server nodes may need to be monitored. Also, operations performed by the extension server nodes may need to be logged. Typically, an arbitrary extension server node may provide monitoring and logging functions specific to the arbitrary extension server node. However, customers of the computing platform may expect that monitoring and logging techniques used for pre-existing server nodes would be available regardless of whether the server is from the pre-existing server nodes or the server is from the newly installed arbitrary extension server nodes. In one embodiment, extension server nodes are adapted to reuse monitoring and logging techniques used for server nodes pre-existing at the cluster of server instance.

A Java Virtual Machine (JVM) may run in a server node. In the JVM multiple requests may be processed in parallel. The different requests operate in different threads. For example, when a program is executed in the JVM to perform a task, a thread of the JVM is assigned to perform the task. Status information for the different threads is generated and reported to a memory external to the JVM to enable monitoring of the thread from external to the JVM. The memory may be shared by multiple JVMs running on a number of server nodes. Reporting slots are registered within the shared memory to store status information for a number of threads. Further reporting slots that may be registered include, but are not limited to, slots that store status information for applications deployed on the server instance, slots that store status information for the server instance itself, status information for aliases, etc. The shared memory may have a predetermined structure and size of slots. The shared memory stores information for current status of the server nodes that are within a server instance.

The status information for threads, applications, server instances, aliases, and so forth, may be retrieved from the shared memory and transmitted to a monitoring console to display the status information. Thus, different server nodes may report various aspects of the server nodes into an external shared memory. The shared memory may be an operational memory of the server instance where the server nodes are running. By reporting status information of the server nodes in the shared memory, reading and writing operations from a database storing status information are surpassed. Monitoring console or other monitoring tools retrieve status information from the shared memory faster compared to when retrieved from a database, for example.

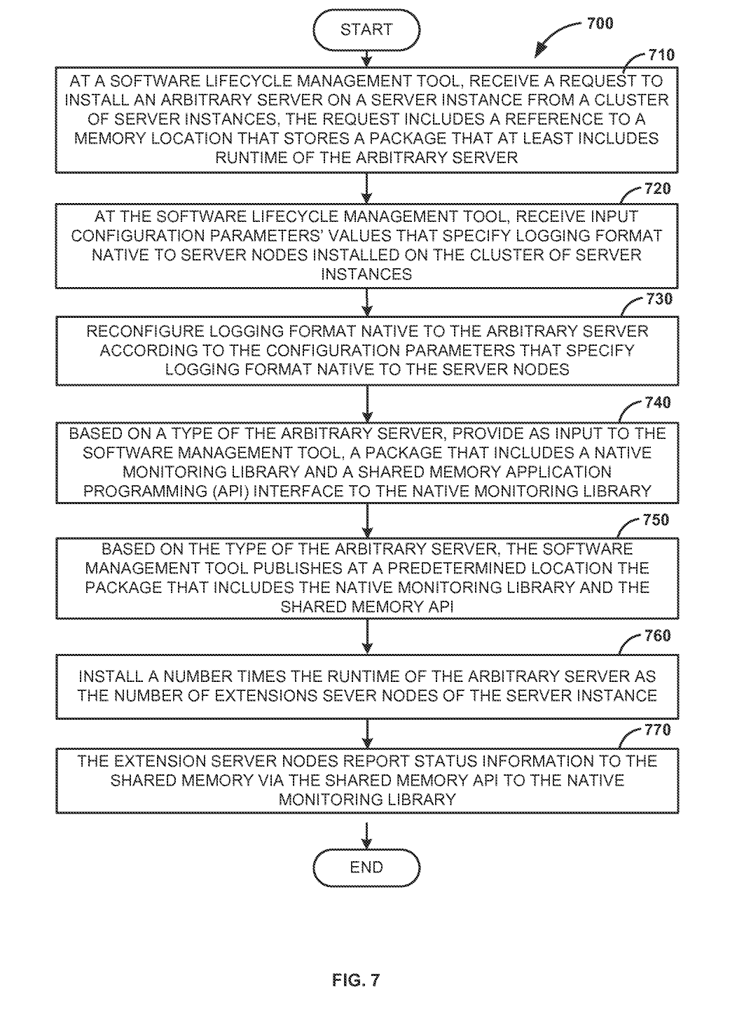

FIG. 7 illustrates process 700 to integrate monitoring and logging performed by a server instance of a cluster of server instances into an arbitrary server that is to be installed as an extension server node on the server instance, according to one embodiment. At 710, a request to install the arbitrary server on the server instance of the cluster of server instances is received at a software lifecycle management tool. The request may include a reference to a memory location that stores a package that at least includes runtime of the arbitrary server.

At 720, input configuration parameter values are received at the software lifecycle management tool. The input configuration parameters' values may specify, among others, logging format that is native to server nodes installed on the cluster of server instances. The logging format native to the server nodes may have predetermined or fixed format and structure. If a log file is in compliance with that format logging tools available at the cluster of server instances may be use such log file to log messages, operations and other relevant information. At 730, logging format that is native to the arbitrary server may be reconfigured according to the configuration parameters' values that specify the logging format native to the server nodes. For example, properties may be customized according to the configuration parameters' values in a properties file specifying logging format of an arbitrary server of type Apache TomEE server. In one embodiment, if the logging format of the arbitrary server is not susceptible to reconfiguration, the logging output of the arbitrary server may be converted to the logging format native to the server nodes by a converter, for example.

Typically, status may be reported to and retrieved from the shared memory of the server instance via a shared memory application programming interface (API). The shared memory API is configured to register status information in the shared memory by invoking executable functions from a monitoring library. The monitoring library may be native to an operating system. Different monitoring libraries may be implemented for different types of operating systems such as Windows, Linux, etc.

The shared memory used for reporting status information by the pre-existing server nodes may have predetermined or fixed format, structure and size. The arbitrary server that is to be installed may not be operable to report all parameters that are required for reporting status information to the shared memory. In one embodiment, the shared memory API is regenerated by separating in one part functionality common for and supported by both the arbitrary server and the server nodes and in another part functionality specific to the arbitrary server.

At 740, a package that includes a native monitoring library and a shared memory application programming interface (API) to the native monitoring library are provided as input to the software management tool. Based on the type of the arbitrary server, at 750, the software management tool publishes the package that includes the native monitoring library and the shared memory APT to a predetermined location. By publishing the shared memory API and the native monitoring library according to specifications of the arbitrary server, the arbitrary server is operable to report status information into the shared memory used by the server nodes within the instance. At 760, the runtime of the arbitrary server is installed a number of times as a number of extension server nodes of the server instance. At 770, the extension server nodes report status information to the shared memory via the shared memory API to the native monitoring library.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise catty a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as Compact Discs Read-Only Memory (CD-ROMs), Digital Video Discs (DVDs) and holographic devices; magneto-optical media; and hardware devices that are specially configured to store and execute, such as application-specific integrated circuits (“ASICs”), programmable logic devices (“PLDs”) and Read-only memory (ROM) and Random-access memory (RAM) devices, memory cards used for portable devices such as Secure Digital (SD) cards. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

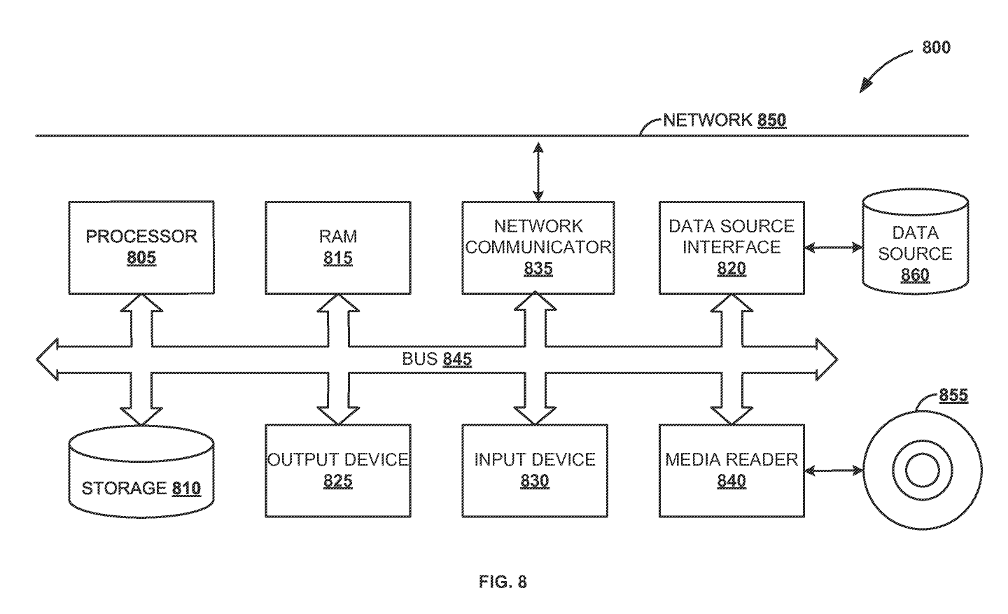

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. These output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data lagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, sonic concurrently with other steps apart from that shown and described herein. In addition, not illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to deploy an application on an arbitrary server installed as one or more extension server nodes on a server instance of a cluster of server instances:
receiving an application package that represents a unit of deployment of the application;
extracting the application package at a memory location of the server instance that stores a runtime of the extension server, the extracted package to be used for subsequent deployments of the application on an extension server node from the one or more extension server nodes; and
based on the extracted application package, deploying the application on the one or more extension server nodes, wherein the one or more extension server nodes are installed on the server instance from the arbitrary server.

2. The method of claim further comprising:
upon successful deployment of the application on each of the one or more extension server nodes, reporting successful transactional deployment of the application on the one or more extension server nodes.

3. The method of claim 1 further comprising:
at an internet communication manager, receive a request from a client system to access functionality provided by the application deployed on the one or more extension server nodes;
handshaking between the client system and the internet communication manager to establish a channel for communication between the client system and the internet communication manager;
upon determining that target of the request is the application deployed on each of the one or more extension server nodes, establishing a channel for communication between the internet communication manager and an extension server node from the one or more extension server nodes; and
forwarding the request to the application running on the extension server node by the internet communication manager via the established channel for communication between the internet communication manager and the extension server node.

4. The method of claim 3 further comprising:
processing the request by the application;
forwarding output from the processing to the internet communication manager via the channel for communication between the internet communication manager and the extension server node; and
forwarding the output to the client system by the internet communication manager.

5. The method of claim 1 further comprising:
receiving a request from a client system to access the application running on an extension server node from of the one or more extension server nodes;
based on the access request, receiving an authentication request at a first component running on the extension server node, the first component provides authentication mechanism to an existing data store;
forwarding the received authentication request to a second component by the first component, the second component represents client implementation of an application programming interface (API) for identity management provided by the cluster of server instances; and
delegating the authentication request to the API, the API to perform the authentication at the cluster of server instances by verifying the authentication information with authentication information stored in one or more authentication data stores at the cluster of sever instances.

6. The method of claim 5 further comprising:
authenticating the client system at the cluster of server instances by the API.

7. The method of claim 5 further comprising:
authorizing the client system at the cluster of server instances by the API.

8. A computer system to deploy an application on an arbitrary server installed as one or more extension server nodes on a server instance of a cluster of server instances, the system comprising:
a memory to store computer executable instructions;
at least one computer processor coupled to the memory to execute the instructions, to perform operations comprising:
receiving an application package that represents a unit of deployment of the application;
extracting the application package at a memory location of the server instance that stores a runtime of the extension server, the extracted package to be used for subsequent deployments of the application on an extension server node from the one or more extension server nodes; and
based on the extracted application package, deploying the application on each of the one or more extension server nodes, wherein the deployment operation is transactional and the one or more extension server nodes installed on the server instance from the arbitrary server.

9. The system of claim 8, wherein the operations further comprise:
upon successful deployment of the application on each of the one or more extension server nodes, reporting successful transactional deployment of the application on each of the one or more extension server nodes.

10. The system of claim 8 further comprising:
at an Internet communication manager, receive a request from a client system to access functionality provided by the application deployed on each of the one or more extension server nodes;
handshaking between the client system and the interact communication manager to establish a channel for communication between the client system and the internet communication manager;
upon determining that target of the request is the application deployed on each of the one or more extension server nodes, establishing a channel for communication between the internet communication manager and an extension server node from the one or more extension server nodes; and
forwarding the request to the application running on the extension server node by the internet communication manager via the established channel for communication between the internet communication manager and the extension server node.

11. The system of claim 10 further comprising:
processing the request by the application;
forwarding output from the processing to the internet communication manager via the channel for communication between the internet communication manager and the extension server node; and
forwarding the output to the client system by the internet communication manager.

12. The system of claim 8 further comprising:
receiving a request from a client system to access the application running on an extension server node from of the one or more extension server nodes;
based on the access request, receiving an authentication request at a first component running on the extension server node, the first component provides authentication mechanism to an existing data store;
forwarding the received authentication request to a second component by the first component, the second component represents client implementation of an application programming interface (API) for identity management provided by the cluster of server instances; and
delegating the authentication request to the API, the API to perform the authentication at the cluster of server instances by verifying the authentication information with authentication information stored in one or more authentication data stores at the cluster of sever instances.

13. The system of claim 12 further comprising:
authenticating the client system at the cluster of server instances by the APT.

14. The system of claim 12 further comprising:
authorizing the client system at the cluster of server instances by the API.

15. A computer implemented method to integrate monitoring and logging performed by a server instance of a cluster of server instances into an arbitrary server that is to be installed as an extension server node on the server instance:
at a software lifecycle management tool, receiving a request to install an arbitrary server on the server instance, the request includes a reference to a memory location that stores a package that at least includes runtime of the arbitrary server;
based on a type of the arbitrary server, providing as input to the software lifecycle management tool, a package that includes a native monitoring library and a shared memory application programming (API) interface to the native monitoring library; and
publishing at a predetermined location the package that includes the native monitoring library and the shared memory API according to a specification of the arbitrary server.

16. The method of claim 15 further comprising:
installing a number times the runtime of the arbitrary server as a number of extensions sever nodes of the server instance.

17. The method of claim 16 further comprising:
reporting status information to the shared memory via the shared memory API to the native monitoring library by the installed extension server nodes.

18. The method of claim 15 further comprising:
at the software lifecycle management tool, receiving input values of configuration parameters that specify logging format native to server nodes installed on the cluster of server instances, and
reconfiguring logging format native to the arbitrary server according to the received input values of configuration parameters that specify logging format native to server nodes.

19. The method of claim 18 further comprising:
installing a number times the runtime of the arbitrary server as a number of extensions sever nodes of the server instance, and
generate logging file based on the reconfigured logging format of the arbitrary server.

20. The method of claim 19 further comprising:
displaying logging data from the generated logging file by a logging tool of the cluster of server instances.
